(19) United States
(12) Patent Application Publication
(10) Pub. No.: US 2015/0263786 A1
(43) Pub. Date: Sep. 17, 2015

(54) METHOD AND HEAD-END EQUIPMENT OF DETERMINING POWER-OFF STATE OF CPE

(71) Applicant: HON HAI PRECISION INDUSTRY CO., LTD., New Taipei (TW)

(72) Inventor: CHIA-HSIEH LIU, New Taipei (TW)

(73) Assignee: HON HAI PRECISION INDUSTRY CO., LTD., New Taipei (TW)

(21) Appl. No.: 14/255,928

(22) Filed: Apr. 17, 2014

(30) Foreign Application Priority Data
Mar. 12, 2014 (TW) 103108764

(51) Int. Cl. H04B 3/54

(52) U.S. Cl. CPC H04B 3/54

(57) ABSTRACT

Head-end equipment determines whether a customer premises equipment (CPE) is powered off. The head-end equipment determines whether the customer premise equipment is offline. The head-end equipment sends a detection request to a smart meter for detecting power consumption of the CPE when the customer premise equipment is offline, and receives a power consumption message sent by the smart meter. The head-end equipment further determines whether the CPE is powered off according to the power consumption message, and releases a channel that is assigned to the CPE when the CPE is powered off.

### FIELD

Embodiments of the present disclosure generally relate to network communication, and more particularly to a method and head-end equipment of getting power off state of Customer Premise Equipment (CPE).

### BACKGROUND

In network communications, when head-end equipment communicates with a CPE and is informed that the CPE is powered off, the head-end equipment will release a channel that is assigned to the CPE, and assign the channel to another CPE. Currently, the head-end equipment determines whether the CPE is powered off based on a Dying Gasp signal, which is sent by the CPE. Generally, the Dying Gasp signal is generated by a special circuit of the CPE. When the CPE is powered off, the special circuit sends the Dying Gasp signal to the head-end equipment.

### BRIEF DESCRIPTION OF THE DRAWINGS

FIG. 1 is a schematic diagram of an embodiment of an application environment of head-end equipment.

FIG. 2 is a block diagram of an embodiment of function modules of the head-end equipment.

FIG. 3 is a detailed transport diagram of sending a detection request and receiving a power consumption message.

FIG. 4 is a flowchart of an embodiment of a method of determining a power-off state of a CPE.

### DETAILED DESCRIPTION

The embodiments are illustrated by way of example and not by way of limitation in the figures of the accompanying drawings in which like references numerals indicate similar elements. It should be noted that references to “an” or “one” embodiment in this disclosure are not necessarily to the same embodiment, and such references can mean “at least one.”

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

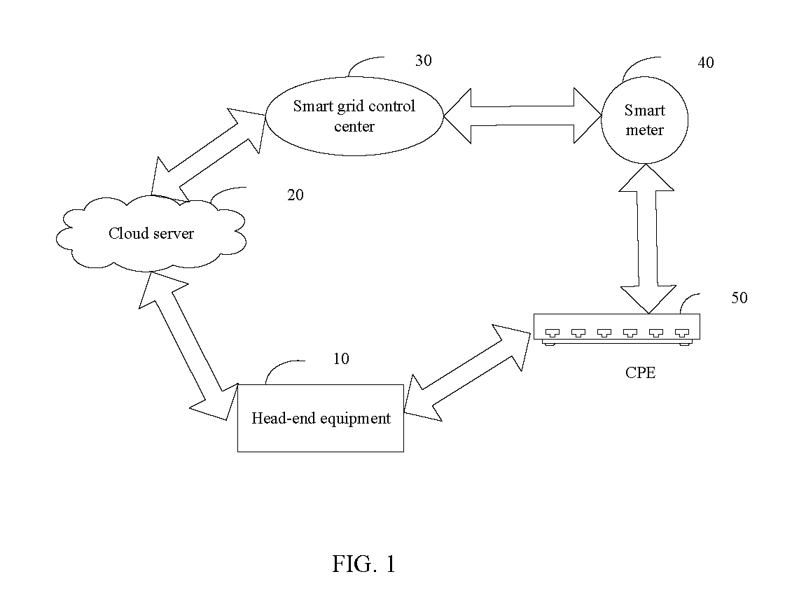

FIG. 1 illustrates a schematic diagram of an embodiment of an application environment of head-end equipment 10. In the present embodiment, the application environment includes the head-end equipment 10, a cloud server 20, a smart grid control center 30, a smart meter 40, and a CPE 50. In the embodiment, the head-end equipment 10, the cloud server 20, and the CPE 50 connect with each other through the Internet, and the smart grid control center 30, the smart meter 40, and the CPE 50 connect with each other through a smart grid. The Internet connects with the smart grid through the smart grid control center 30. In the embodiment, the head-end equipment 10 is located on an Internet Service Provider (ISP), and arranges channels to the CPE 50. In the embodiment, the CPE 50 can be network equipment such as a modem, a connecter, a switcher, or a router. In the embodiment, once the CPE 50 is powered off, the head-end equipment 10 will release channels that are assigned to the CPE 50.

In the present embodiment, the smart grid can use power lines to transmit messages. The smart grid can also have other functions such as monitoring, diagnosing, and repairing. In the embodiment, the smart meter 40 can calculate a power consumption of each circuit load, and send out power consumption messages.

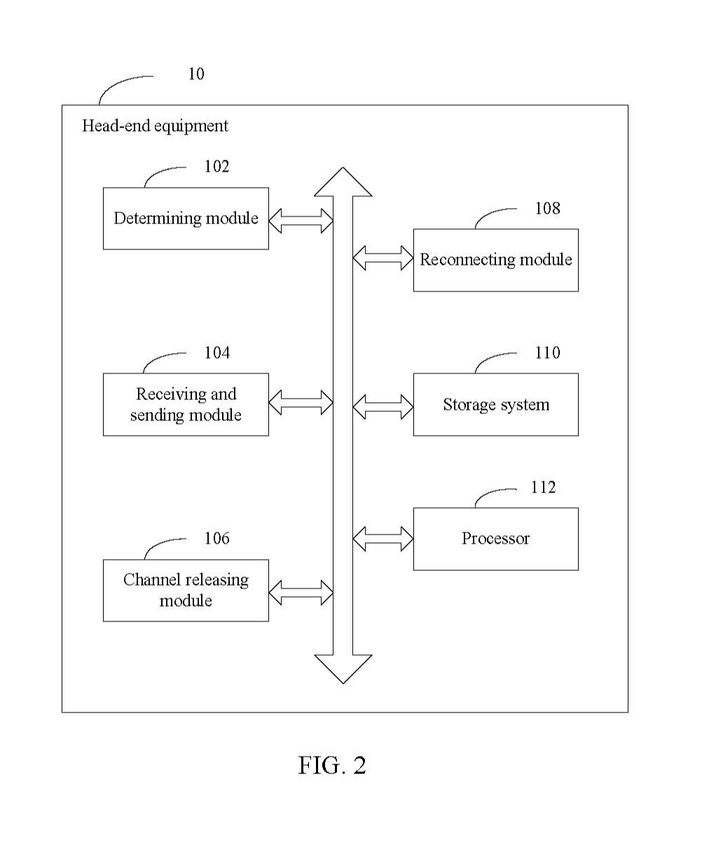

FIG. 2 illustrates a block diagram of an embodiment of function modules of the head-end equipment 10. In the embodiment, the head-end equipment 10 comprises a determining module 102, a receiving and sending module 104, a channel releasing module 106, a reconnecting module 108, a storage system 110, and a processor 112.

The modules 102-108 can comprise one or more software programs in the form of computerized codes stored in the storage system 110. The computerized codes include instructions executed by the processor 112 to provide functions for the modules 102-108.

The determining module 102 determines whether the CPE 50 is offline. In the embodiment, when data sent to the CPE 50 decreases or disappears, the head-end equipment 10 determines that the CPE 50 is offline.

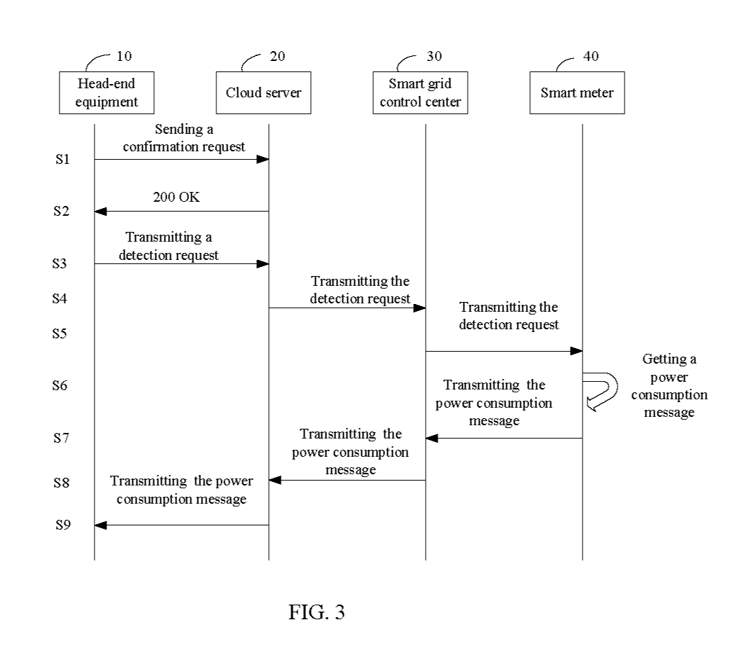

The receiving and sending module 104 sends a detection request to the smart meter 40 via the Internet and smart grid. The detection request is for detecting power consumption of the CPE 50. In the embodiment, the detection request is sent through the cloud server 20, the smart grid control center 30, and the smart meter 40 in sequence. FIG. 3 illustrates a detailed transport diagram of sending the detection request and receiving the power consumption message. In S1, the receiving and sending module 104 sends a confirmation request to the cloud server 20 to confirm that a connection of the head-end equipment 10 and the cloud server 20 is OK. In S2, the cloud server 20 sends a 200 OK status code to the head-end equipment 10 to tell the head-end equipment 10 that the connection between the head-end equipment 10 and the cloud server 20 is OK. In S3, the head-end equipment 10 sends the detection request to the cloud server 20. In S4, the cloud server 20 transmits the detection request to the smart grid control center 30. In S5, the smart grid control center 30 transmits the detection request to the smart meter 40.

In the present embodiment, the detection request comprises an Internet protocol (IP) address of the CPE 50. The IP address of the CPE 50 is used to find the CPE 50.

The receiving and sending module 104 receives a power consumption message. The power consumption message is sent by the smart meter 40 according to the detection request. In the embodiment, the power consumption message is sent through the smart grid control center 30 and the cloud server 20. In S6, the smart meter 40 receives the power consumption message of the CPE 50 according to the detection request. The power consumption message comprises real-time power consumption of the CPE 50. In S7, the smart meter 40 transmits the power consumption message to the smart grid control center 30. In S8, the smart grid control center 30 transmits the power consumption message to the cloud server 20. In S9, the cloud server 20 transmits the power consumption message to the head-end equipment 10.

In the present embodiment, when the receiving and sending module 104 receives the power consumption message sent by the smart meter 40, the determining module 102 determines whether the CPE 50 is powered off. In the embodiment, when the real-time power consumption in the power consumption message is lower than a predefined value, the determining module 102 determines that the CPE 50 is powered off. In the embodiment, the predefined value is 0.3 kilowatt hours. In other embodiments, the predefined value can be set to different values according to actual needs.

The channel releasing module 106 releases channels that are assigned to the CPE 50 when the determining module 102 determines that the CPE 50 is powered off. In the embodiment, the head-end equipment 10 arranges channels for the CPE 50 for transmitting data.

The reconnecting module 108 reconnects the CPE 50 when the CPE 50 is not powered off. In the embodiment, when the real-time power consumption in the power consumption message is not lower than the predefined value, the CPE 50 is not powered off and may have a broken network connection, so the CPE 50 is reconnected.

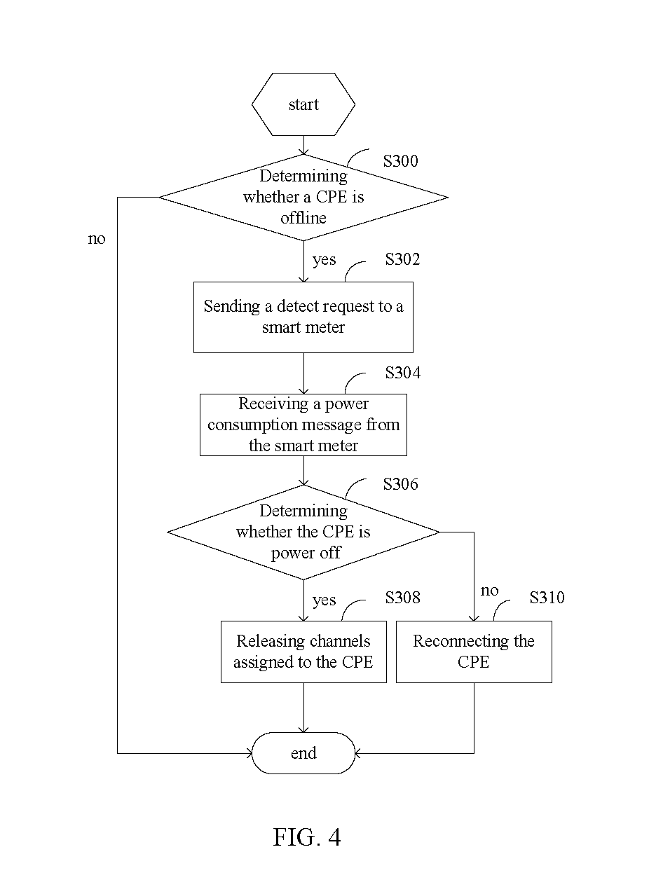

FIG. 4 illustrates a flowchart of an embodiment of determining whether the CPE 50 is powered off. In the embodiment, the method is implemented in the application environment shown in FIG. 1 in the following manner and executed by the head-end equipment.

In block S300, the determining module 102 determines whether the CPE 50 is offline. In the present embodiment, when the data sent to the CPE 50 decreases or disappears, the head-end equipment 10 determines that the CPE 50 is offline.

In block S302, the receiving and sending module 104 sends the detection request to the smart meter 40 according to the Internet and the smart grid. In the embodiment, the detection request is sent through the cloud server 20, the smart grid control center 30, and the smart meter 40 in sequence. FIG. 3 illustrates a detailed transport diagram of sending the detection request and receiving the power consumption message. In S1, the receiving and sending module 104 sends a confirmation request to the cloud server 20 to confirm that a connection of the head-end equipment 10 and the cloud server 20 is OK. In S2, the cloud server 20 sends a 200 OK status code to the head-end equipment 10 to tell the head-end equipment 10 that the connection between the head-end equipment 10 and the cloud server 20 is OK. In S3, the head-end equipment 10 sends the detection request to the cloud server 20. In S4, the cloud server 20 transmits the detection request to the smart grid control center 30. In S5, the smart grid control center 30 transmits the detection request to the smart meter 40.

In the present embodiment, the detection request comprises an Internet protocol (IP) address of the CPE 50. The IP address of the CPE 50 is used to find the CPE 50.

In block 5304, the receiving and sending module 104 receives the power consumption message which is sent back by the smart meter 40 according to the detection request. In the embodiment, the power consumption message is sent through the smart grid control center 30 and the cloud server 20. In S6, the smart meter 40 receives the power consumption message of the CPE 50 according to the detection request. The power consumption message comprises real-time power consumption of the CPE 50. In S7, the smart meter 40 transmits the power consumption message to the smart grid control center 30. In S8, the smart grid control center 30 transmits the power consumption message to the cloud server 20. In S9, the cloud server 20 transmits the power consumption message to the head-end equipment 10.

In block S306, the determining module 102 determines whether the CPE 50 is powered off according the power consumption message. In the embodiment, when the real-time power consumption in the power consumption message is lower than a predefined value, the determining module 102 determines that the CPE 50 is powered off. In the embodiment, the predefined value is 0.3 kilowatt hours. In other embodiments, the predefined value can be set according to actual needs.

In block S308, the channel releasing module 106 releases the channels that are assigned to the CPE 50 when the determining module 102 determines that the CPE 50 is powered off. In the embodiment, the head-end equipment 10 arranges channels for the CPE 50 for transmitting data.

In block S310, the reconnecting module 108 reconnects the CPE 50 when the CPE 50 is not powered off. In the embodiment, when the real-time power consumption in the power consumption message is not lower than the predefined value, the CPE 50 is not powered off and may have a broken network connection, so the CPE 50 is reconnected.

In summary, the head-end equipment in the present disclosure can get power off state of the CPE without a special circuit which generates a Dying Gasp signal, thus the CPE will increase its using life and decreasing its cost.

While various embodiments and methods have been described above, it should be understood that they have been presented by way of example only and not by way of limitation. Thus the breadth and scope of the present disclosure should not be limited by the above-described embodiments, and should be at least commensurate with the following claims and their equivalents.

1. A head-end equipment connected with a customer premise equipment and a smart meter, the head-end equipment comprising at least one processor, a storage system, and one or more programs stored in the storage system and executed by the at least one processor, the one or more programs comprising:
a determining module, configured to determine whether the customer premise equipment is offline by detecting whether data sent to the customer premise equipment decreases or disappears;
a receiving and sending module, configured to send a detection request to the smart meter to detect power consumption of the customer premise equipment on condition that the customer premise equipment is offline, and receive a power consumption message which is sent by the smart meter, wherein the determining module further configured to determine whether the customer premise equipment is powered off according to the power consumption message; and
a channel releasing module, configured to release channels that are assigned to the customer premise equipment on condition that the determining module determines that the customer premise equipment is powered off.

2. The head-end equipment of claim 1, further comprising a reconnecting module configured to reconnect the customer premise equipment in the event that the determining module determines that the customer premise equipment is not powered off.

3. The head-end equipment of claim 1, wherein the detection request comprises an Internet protocol address of the customer premise equipment.

4. The head-end equipment of claim 1, wherein the power consumption message comprises a real-time power consumption of the customer premise equipment.

5. The head-end equipment of claim 4, wherein the determining module further configured to determine that the customer premise equipment is powered off in the event that the real-time power consumption of the customer equipment is lower than a predefined value, and determine that the customer premise equipment is not powered off in the event that the real-time power consumption of the customer equipment is not lower than the predefined value.

6. A method of getting a power off state of a customer premise equipment, applied to a head-end equipment which is connected with the customer premise equipment and a smart meter, the method comprising:
determining whether the customer premise equipment is offline by detecting whether data sent to the customer premise equipment decreases or disappears;
sending a detection request to the smart meter to detect power consumption of the customer premise equipment on condition that the customer premise equipment is offline;
receiving a power consumption message which is sent by the smart meter;
determining whether the customer premise equipment is powered off according to the power consumption message; and
releasing channels that are assigned to the customer premise equipment on condition that the customer premise equipment is powered off.

7. The method of claim 6, further comprising:
reconnecting the customer premise equipment in the event that the customer premise equipment is powered off.

8. The method of claim 6, wherein the detection request comprising an Internet protocol address of the customer premise equipment.

9. The method of claim 6, wherein the power consumption message comprising a real-time power consumption of the customer premise equipment.

10. The method of claim 9, wherein determining whether the customer premise equipment is powered off comprises:
determining that the customer premise equipment is powered off in the event that the real-time power consumption of the customer equipment is lower than a predefined value; and
determining that the customer premise equipment is not powered off in the event that the real-time power consumption of the customer equipment is not lower than the predefined value.
